(19) United States
(12) Patent Application Publication
(10) Pub. No.: US 2011/0110546 A1
(43) Pub. Date: May 12, 2011

(54) SPEAKER

(76) Inventors: San-You Wu, Shenzhen (CN); Xiong Zhang, Shenzhen (CN)

(21) Appl. No.: 12/855,565

(22) Filed: Aug. 12, 2010

(30) Foreign Application Priority Data
Nov. 9, 2009 (CN) 200920260181.6

(51) Int. Cl. H04R 25/00

(52) U.S. Cl. 381/322

(57) ABSTRACT

A speaker includes a case defining a central hole therein, a bowl-shaped yoke received in the central hole of the case, a magnet fixed in the yoke, a vibrating coil suspended a magnetic gap formed between the magnet and the yoke, a diaphragm coupled to the vibrating coil, and an hearing aid coil embedded in the case.

### FIELD OF THE INVENTION

The present invention generally relates to the art of speakers, more particularly to a speaker having a hearing aid coil (HAC).

### RELATED ART OF THE INVENTION

A related speaker having a hearing aid coil generally comprises a case having a receiving space, a bowl-shaped yoke assembled in the receiving space of the case, a magnet fixed in the bowl-shaped yoke, a vibrating coil suspended in a magnetic gap formed between the magnet and the yoke, a diaphragm coupled to the coil, a hearing aid coil, and a cover coupled to the case for accommodating the above-mentioned components. The bowl-shaped yoke comprises a bottom and a side extending approximately perpendicular from the bottom. The bottom and a part of the side come out of the receiving space of the case. The hearing aid coil is wound around the side of the yoke. In order to fix the hearing aid coil to the side, glue is used. The hearing aid coil is used for providing enhanced sound to users with hearing disorder. It is easy to wind the hearing aid coil around the yoke. However, the hearing aid coil is exposed outside and is easily to be damaged. Further, glue is used to fix the coil, and the glue pollutes the environment.

Accordingly, it is necessary to provide an improved speaker for solving the problems mentioned above.

### SUMMARY OF THE INVENTION

In one exemplary embodiment of the present invention, a speaker comprises a case defining a central hole therein, a yoke received in the central hole of the case and defining a bottom and a side approximately perpendicular to the bottom, a magnet fixed in the yoke, a vibrating coil suspended a magnetic gap formed between the magnet and the yoke, a diaphragm coupled to the vibrating coil, and a hearing aid coil surrounding the side of the yoke and being embedded in a slot defined in the case.

Other features and advantages of the present invention will become more apparent to those skilled in the art upon examination of the following drawings and detailed description of the exemplary embodiment.

### BRIEF DESCRIPTION OF THE DRAWINGS

FIG. 1 depicts an isometric view of a speaker in accordance with one exemplary embodiment of the present invention;

FIG. 2 is an isometric view of the speaker in FIG. 1 from another aspect;

FIG. 3 illustrates a cross-sectional view of the speaker taken along Line A-A in FIG. 1; and

FIG. 4 depicts an exploded view of the speaker.

### DETAILED DESCRIPTION OF THE EXEMPLARY EMBODIMENT

Reference will now be made to describe one exemplary embodiment of the present invention in detail.

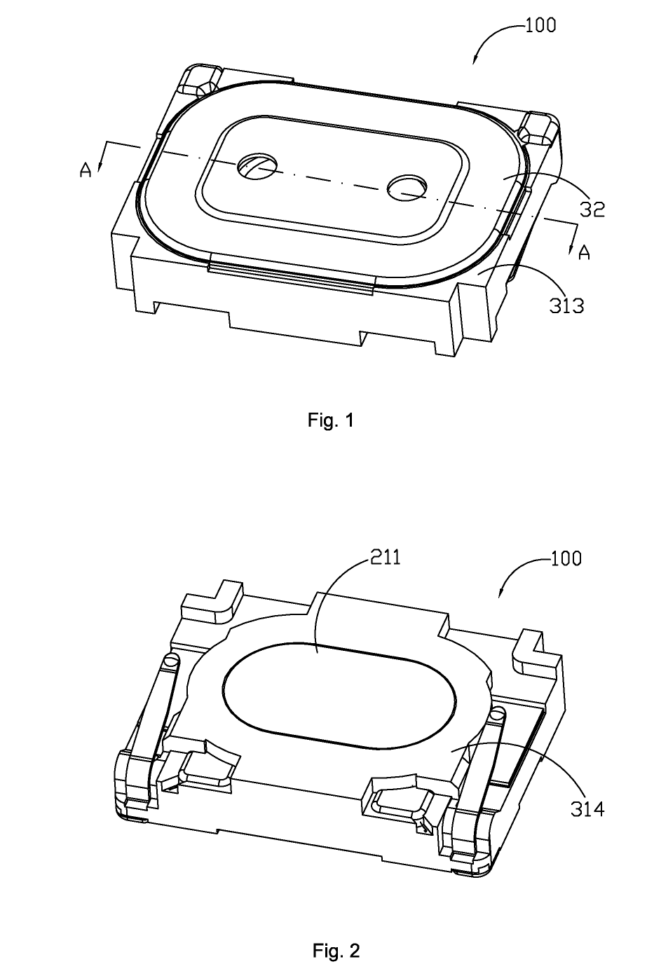

Referring to FIGS. 1-4, a speaker 100, in accordance with one exemplary embodiment of the present invention, includes a case 31, a yoke 21 fixed in the case 31, a magnet 22 positioned in the yoke 21 together with a plate 23 attached to an upper surface thereof, a vibrating coil 12 suspended in a magnetic gap formed between the yoke 21 and the magnet 22, a diaphragm 11 coupled to the coil 12, a hearing aid coil 34 embedded in the case 31, and a cover 32 coupled to the case 31.

The diaphragm 11 includes a central part 111 and a peripheral part 112 around the central part 111.

The vibrating coil 12 is attached to the diaphragm 11.

The case 31 defines a central hole 311 for receiving the yoke 21. The case 31 defines an upper side 313 close to the cover 32 and a lower side 314 opposite to the upper side 313.

The yoke 21 defines a bottom 211 for carrying the magnet 22 thereon and a side 212 approximately perpendicular to the bottom 211.

Generally, the cover 32 is made of a metal plate and is close to the diaphragm 11 for coupling a peripheral portion of the diaphragm 11 to the upper side 313 of the case 31.

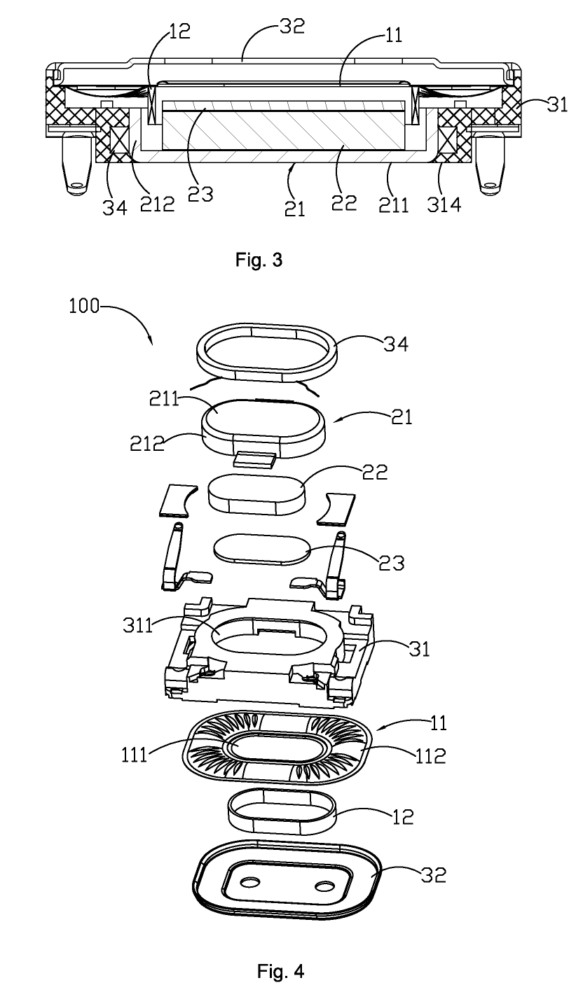

The hearing aid coil 34 is a ring surrounding side 212 of the yoke 21. In order to be protected, the hearing aid coil 34 is received in a slot defined in the case 31. While assembled, the hearing aid coil 34 is embedded in the case 31. It is preferable that the hearing aid coil 34 is received in the case 31 by insert-molding. It is further preferable that the hearing aid coil 34 is received in the slot of the case with one outer surface touching the side of the yoke 21. Furthermore, the bottom 211 of the yoke 21 is coplanar with the lower side 314 of the case 31, as shown in FIG. 3. As the hearing aid coil 34 is embedded in the case, it is protected from damaging.

When electrified, the vibrating coil 12 is forced to move and to drive the diaphragm 11 to move for producing sound. At the same time, the hearing aid coil 34 can provide an alternating magnetic field responding with the hearing aids of the person with hearing disorder for helping the person hear some sound.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A speaker, comprising:
a case defining a central hole therein;
a yoke received in the central hole of the case, the yoke defining a bottom and a side approximately perpendicular to the bottom;
a magnet fixed in the yoke;
a vibrating coil suspended a magnetic gap formed between the magnet and the yoke;
a diaphragm coupled to the vibrating coil;
a hearing aid coil surrounding the side of the yoke and being embedded in a slot defined in the case.

2. The speaker as described in claim 1, wherein the hearing aid coil is embedded is in the case with one outer surface touching the side of the yoke.

3. The speaker as described in claim 1, wherein the case comprises an upper side and a lower side opposite to the upper side, and the lower side is coplanar with the yoke.

4. A speaker, comprising:
a case defining a central hole therein and a ring-shaped slot;
a yoke received in the central hole of the case, the yoke defining a bottom and a side approximately perpendicular to the bottom;
a magnet fixed in the yoke;
a vibrating coil suspended a magnetic gap formed between the magnet and the yoke;
a diaphragm being capable of being activated by the vibrating coil; wherein the slot surrounds the side of the yoke and a hearing aid coil is embedded in the slot of the case.
